(19) United States
(12) Patent Application Publication
(10) Pub. No.: US 2006/0254799 A1
(43) Pub. Date: Nov. 16, 2006

(54) Instant wire splice wrap

(76) Inventor: Mark R. Gregorek, Mahwah, NJ (US)

Correspondence Address: WARD & OLIVO;Suite 300, 382 Springfield Ave., Summit, NJ, 07901, US

(21) Appl. No.: 11/135,940

(22) Filed: May 24, 2005

(51) Int. Cl. H02G 15/02

(52) U.S. Cl. 174/74 A

(57) ABSTRACT

A method and apparatus for quickly, economically, and securely splicing wires is disclosed. The quick wire splice wrap is installed in seconds without the use of external crimping tools, implements, or appliances.

### FIELD OF THE INVENTION

The present invention relates generally to the field of wire splices and connectors and, more particularly, to a method and apparatus for splicing wires quickly, economically, and effectively without the use of external crimping instruments.

### BACKGROUND OF THE INVENTION

Electrical wire splices and connectors are commonly used in the manufacturing, re-manufacturing, reverse manufacturing, modifying, updating, and replacement of electrical wire assemblies. For example, in the automotive industry, there may be numerous wire splices and/or connectors in one wire assembly in order to transmit electrical energy to outlying lights and various automotive accessories. In addition, electrical wire splices are commonly used to repair, replace, or add common electrical household devices, such as lights, electrical switches, outlets, and ceiling fans.

There are several common methods of splicing electrical wires or connectors. One method of splicing electrical wires involves stripping the insulation from the wires to be spliced thereby exposing the bare wires. The bare wires are then typically welded, taped, or soldered to form a suitable electrical connection.

An alternative method of splicing electrical wires without the use of solder comprises stripping the insulation from the end of each wire to be spliced and placing each end in a crimped band or conductor. The band is subsequently secured to the wires by firmly crimping the band about the wires, creating electrical continuity between the now joined ends of the wires. Typically, hand crimping tools or pliers are used to exert enough force to secure the band around the ends of the wires to be spliced together.

A third method of splicing electrical wires does not require stripping the insulation from the wires to be spliced in order to expose the conductors. The wires are positioned within a wire splice connector. The wire splice connector is closed and then crimped shut causing a conductive male tab to cut across part of each wire, effectively forming an electrical fusion between the wires. These self-stripping splice connectors are manufactured in a variety of sizes and shapes to accommodate various wire types and gauges.

Yet another method of splicing electrical wires comprises a tap-splice connector. These connectors tap into a wire mid-span without the need for cutting or stripping the wires to be spliced. One side of the tap-splice connector surrounds a first wire to be tapped mid-span. The other side of the tap-splice connector is closed on a second wire to be spliced. A conductive male tab makes contact with both the first tapped wire and the second wire, creating a tap-splice with the other wire. Tap-splice connectors are commonly used when adding or upgrading electrical devices to an electrical wire already in service.

Twist-on wire nuts may also be used to splice two or more electrical wires. Conventional wire nuts are made up of a cone shaped plated steel spring that conforms to the inside contour of an insulating shell. The insulating shell supports the spring as stripped wires are driven up into the cone. The wires are twisted together as the insulating shell is twisted, securing the wire therein to create a wire connection. Twist-on wire nuts may be used to make branch circuit or fixture wire connections for the combination of solid and/or stranded wire. The twisting motion joins the bare conductors of the wires to be spliced and creates a protected wire termination.

Before any of the foregoing wire splices can be put into service, the bare conductors must be insulated against undesired short circuits and sealed against contaminants. This helps prolong the life of the electrical wire splice while maintaining optimal electrical continuity. Wire nuts and connectors offer only minimal inherent protection from nominal environmental conditions, resulting in unwanted short circuits. For more comprehensive protection, spliced wires are commonly protected from contaminants in a variety of ways.

U.S. Pat. No. 4,731,500, entitled “Electrical Shielding Tape and Method for Making Same,” to Otsuka, discloses a common way to protect a wire splice. Otsuka discloses an electrical splice wrapped with plastic electrical insulating tape to shield the splice from short circuits and contaminants. Electrical insulating tapes are manufactured in a variety of sizes and thicknesses (for example, electrical tapes offered for sale by 3M Electrical Markets Division exhibit a standardized thickness of either 7 or 10 mils). Electrical insulating tapes are also typically resistant to corrosion, tearing, and external radiation. Electrical insulating tapes may also contain an adhesive on the underside of the tape backing to secure the tape to the spliced area. Common adhesives used in electrical tapes include acrylic adhesives, cellulose or gums, epoxies, glues, polyurethanes (PUR) and urethanes, rubber, and silicone. Many of these adhesives have additional characteristics that allow special use cases for the electrical tapes. Some of these additional properties include thermosetting adhesives (i.e., adhesives that bond when heat is used), water activated adhesives, and pressure sensitive adhesives (PSA).

U.S. Pat. No. 6,545,219, entitled “Wrap-around cable Sleeves Having an Expandable Body Portion and Methods of Making Same,” to Bukovnik, et al., discloses a wrap-around cable sleeve for environmentally sealing a cable section. The wrap-around cable sleeve includes an expandable body comprising an electrically insulating material. The wrap-around sleeve also has a longitudinally extending portion with a corrugated lateral cross-section. The longitudinally extending portion defines a portion of a cable chamber, which extends around the cable section when the body is wrapped around the cable section. Complicated means are used to secure the cable within the cable sleeve and close the sleeve, including various spring clamps, latching connectors, and pin members.

Other methods to protect a wire splice include heat-shrink splice kits and sleeves. As disclosed in U.S. Pat. No. 6,367,990, entitled “Heat-shrinkable Tube for Protection of Optical Fiber Splices,” to Dumitriu, a mild heat source is typically applied to a heat-shrink splice sleeve causing the sleeve to shrink around a splice. After heating, the sleeve adheres and forms an environmental seal, protecting the splice from adverse environmental conditions (including submersion in water). Heat-shrink splice sleeves are typically heated with a torch or special heat-shrink oven and offer protection in varying environmental conditions.

A final way to protect wire splices is to enclose the splice within a gel-filled sealant chamber as disclosed in U.S. Pat. No. 5,828,005, entitled “Gel-filled Closure,” to Huynh-Ba, et al. Typically, these chambers are filled with a suitable gel sealing material, such as silicone gel, urea gel, or urethane gel, and form a moisture-tight seal around a splice for a high degree of protection. These gels are typically corrosion and thermal resistant and are able to withstand a wide range of environmental conditions.

However, all of the traditional aforementioned electrical wire splices and protection devices are relatively difficult to install and maintain. The common method conveyed by Otsuka is ineffective and incompliant with various municipal codes and other administrative regulations. In addition, many of the methods mentioned above require heavy equipment, heat sources (for heat-shrink splices), or laborious effort to secure an electrical wire splice and preserve electrical continuity. For example, crimping tools, pliers, or even torches or ovens are required to install these inconvenient electrical splice devices. Thus, a clear need exists for a quick and efficient method for creating and protecting a wire splice in seconds without the use of external tools, implements, or appliances.

In addition, conventional wire splicing methods often leave the splice vulnerable to damage due to foreign objects or stray conductors puncturing the protection device. These devices fail to prevent degradation of the electrical continuity of the splice (or, in the case of signal transmission wires, deterioration of signal quality) caused by excessive bending or pulling of the spliced wires.

It would be advantageous if an electrical wire splice could be installed quickly and securely by hand without the use of external tools, implements, or appliances. It would also be advantageous if an electrical wire splice could be installed in seconds that protects the spliced wires from outside contaminants and short circuits while at the same time being resistant to punctures and tears. Thus, an easy to install, convenient, and durable device is needed for quickly and economically splicing electrical wires.

### SUMMARY OF THE INVENTION

The present invention is directed toward a method for splicing electrical wires. The wires to be spliced are first stripped of a portion of insulation exposing the bare ends of the wires. A hollow core with a wrap consisting of a non-conductive, flexible, latex-based or other type of rubber or plastic material rolled back upon itself about the core is then slid over the terminal end of a first wire to be spliced. Next, the bare end of a second wire to be spliced is brought in contact with the bare end of the first wire, and the two wires are pressed or twisted together by hand. The hollow core is then positioned over the area where the insulation ends of the first wire to be spliced and pressed firmly by hand. This pressure may cause the hollow core to break away, or fracture, thereby locking the non-conductive, prophylactic-type wrap in place. The wire wrap is then unrolled down the wire and tightly embraces, encompasses, and secures itself around the bare conductors of the wires to be spliced. The wrap completely encompasses the bare conductors, thereby insulating and protecting the splice.

The present invention is also directed toward a device for quickly and securely splicing electrical wires by those with less than normal dexterity. The present invention comprises a wire wrap, rolled back upon itself around a hollow core, which is adapted to fit over an electrical wire. The present invention is installed in seconds by sliding the core over a terminal end of one or more wires to be spliced with one or more other wires. The device is then positioned over the end of one wire to be spliced and pressed firmly by hand. The pressure causes the hollow core to break, thereby locking the present invention in place over the terminal end of a first wire to be spliced. The wire wrap is then unrolled over to the bare conductors of the wires to be spliced until the wrap is fully unrolled. The device protects the spliced wires from short circuits and contaminants while securely holding the splice in place.

### BRIEF DESCRIPTION OF THE DRAWINGS

A further understanding of the present invention can be obtained by reference to a preferred embodiment as set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the specific methods and instrumentalities disclosed.

For a more complete understanding of the present invention, reference is now made to the following drawings in which:

FIG. 1 is an illustration of the present invention in its packaged form in accordance with the preferred embodiment of the present invention;

FIGS. 2A, 2B, and 2C are illustrations of the various core shapes for use with the preferred embodiment of the present invention;

FIGS. 3A, 3B, and 3C are illustrations showing the present invention in its various unrolled forms in accordance with the preferred embodiment of the present invention;

FIG. 4 depicts the present invention positioned over the terminal end of a first wire to be spliced;

FIG. 5 depicts the present invention positioned over the terminal end of a first wire to be spliced with a second wire;

FIG. 6 depicts the fracturing of the core and the resultant shards;

FIG. 7 is an illustration depicting the present invention partially unrolled to cover part of the bare conductors of the two wires to be spliced;

FIG. 8 depicts the present invention fully unrolled and fully encompassing the bare conductors of the two spliced wires;

FIG. 9 depicts an alternative embodiment where the present invention is used to splice more than two wires;

FIG. 10 is an illustration of the present invention in its rolled form in accordance with an alternative embodiment of the present invention;

FIG. 11 depicts the present invention of FIG. 10 positioned up to the bare conductors of two wires about to be spliced;

FIG. 12 depicts the fracturing of the core and the resultant shards of the alternative embodiment of the present invention of FIG. 10;

FIG. 13 is an illustration depicting the present invention of FIG. 10 partially unrolled to cover part of the bare conductors of the two wires to be spliced; and

FIG. 14 depicts the alternative embodiment of the present invention of FIG. 10 fully unrolled and encompassing the bare conductors of the spliced wires.

### DETAILED DESCRIPTION OF THE PREFERRED EMBODIMENTS

A detailed illustrative embodiment of the present invention is disclosed herein. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for the purposes of disclosure and to provide a basis for the claims herein, which define the scope of the present invention. The following presents a detailed description of a preferred embodiment (as well as some alternative embodiments) of the present invention.

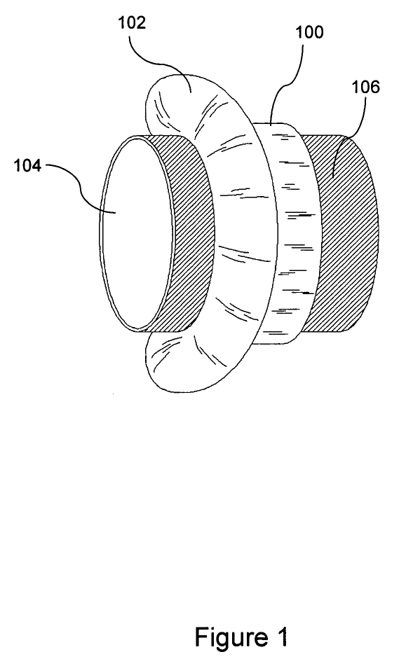

Referring to FIG. 1, the preferred embodiment of the present invention is depicted in its packaged form. Wrap 100 is preferably open at both ends and may comprise plastic, any substances commonly associated with plastic, derivatives thereof, alloys, and blends, including PVC, synthetic resin, vinyl, rubber, thermosets, latex, elastomers, thermoplastics, or any other like material with a suitable resistivity for wire splicing. In addition, wrap 100 may comprise an electrical insulating backing commonly known in the art, such as glass cloth, acetate cloth, cotton cloth, composite film, epoxy film, paper, polyimide film, polyester film, or other like materials. In the preferred embodiment, wrap 100 is a flexible, yet highly elastic, PVC-based vinyl wrap approximately 7 mils thick with an insulation resistance of approximately 10⁶ megaohms. It should be understood that wrap 100 may exhibit any suitable insulation resistance and may be produced in any convenient thickness without departing from the spirit of the present invention. In the preferred embodiment, wrap 100 may also have a rubber-based pressure-sensitive adhesive (PSA) on under surface 102 of wrap 100 allowing the wrap to stay in place once unrolled, thereby stabilizing the wrap to maintain its position over the splice. This adhesive may comprise a thermosetting rubber adhesive, an acrylic adhesive, a thermosetting silicon adhesive, a non-thermosetting rubber adhesive, a micro-encapsulated adhesive, or any other adhesive commonly used in the art. In the preferred embodiment, wrap 100 exhibits excellent resistance to abrasion, moisture, alkalis, acids, copper corrosion, and varying weather conditions (including ultraviolet exposure) due to its PVC-based vinyl composition and additives. Wrap 100 in its packaged form is preferably rolled back upon itself about core 106 several times until wrap 100 is almost completely rolled back upon itself. In the preferred embodiment, core 106 is approximately 1 cm in length and is composed of plastic, glass, or any other fracturable or dissolvable material; however, core 106 may be of any convenient length depending on the length, thickness, and other qualities of wrap 100 or the gauge of wires to be spliced.

Still referring to FIG. 1, core 106 may contain a laminate (not shown) to inhibit adhesion of wrap 100 to core 106. This laminate may also facilitate effortless unrolling of wrap 100 over the wires to be spliced. In the preferred embodiment, this laminate may comprise a wax or Teflon® coating, but other fluoropolymers, such as PTFE, and other waxes and/or lubricants, may also be used. Core 106 comprises inner surface 104, which is adapted to fix around the terminal end of at least one wire to be spliced. Inner surface 104 of core 106 may additionally comprise a backing, laminate, or lubricant (not shown) to facilitate installation over at least one wire.

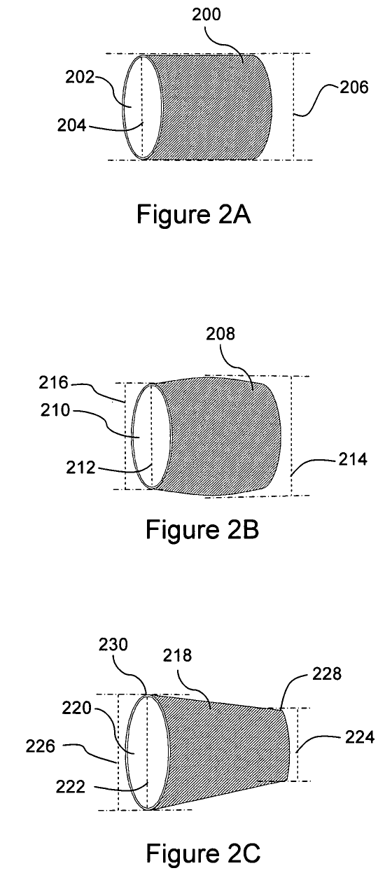

Now referring to FIG. 2A, core 200 of the present invention is generally cylindrical or tubular in the preferred embodiment. Inner surface 202 of core 200 exhibits inner diameter 204 which is generally uniform throughout the length of core 200. Outer diameter 206 may be slightly larger than inner diameter 204, and a gel or adhesive layer may be inserted within the core.

Although the illustrated embodiments depict generally cylindrical or tubular cores, generally cylindrical or tubular expressly includes diamond, hexagonal, octagonal, and any other polygonal cores. In fact, the core of the present invention may comprise any convenient geometry that is adapted to fit over the terminal end of at least one wire. In alternative embodiments, core 208 may flare or bulge out in the midsection to facilitate easy handling and grasping, as shown in FIG. 2B. In this embodiment, inner surface 210 of core 208 exhibits inner diameter 212 which fluctuates throughout the length of core 208. Inner diameter 212 may be slightly smaller than outer diameter 216, allowing a layer of gel or adhesive to be inserted within the core. Core 208 also exhibits bulge diameter 214 at the approximate center of core 208, which may be greater than both inner diameter 212 and outer diameter 216.

Other core configurations may also be used, including tapered cores, as shown in tapered core 218 of FIG. 2C. Tapered core 218 may ease unrolling and installation of the present invention over at least one wire. Tapered core 218 exhibits minor diameter 224 at first end 228 and major diameter 226 at the second end 230. Inner surface 220 of tapered core 218 may also exhibit inner diameter 222, which may start slightly smaller than major diameter 226 and taper to exhibit a diameter slightly smaller than minor diameter 224. A layer of gel or adhesive may be inserted within tapered core 218.

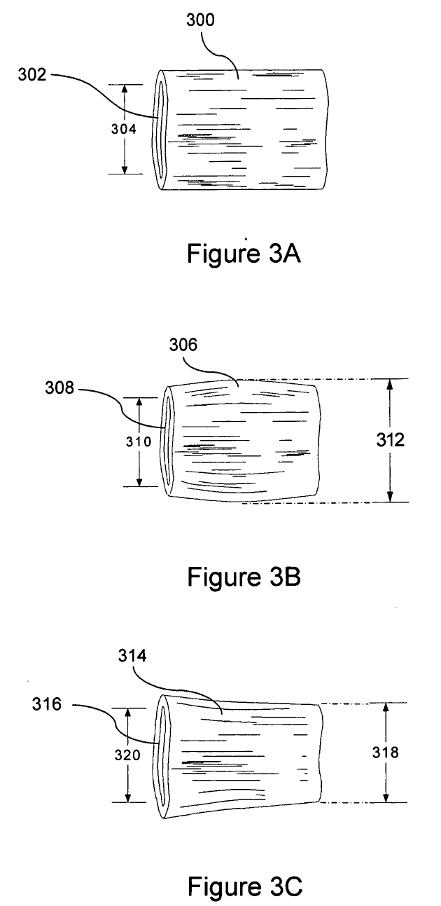

FIGS. 3A, 3B, and 3C show the corresponding unrolled wraps for use with the cores of FIGS. 2A, 2B, and 2C. In the preferred embodiment, unrolled wrap 300 is highly elastic and may be generally cylindrical or tubular in shape, as depicted in FIG. 3A; however, unrolled wrap 300 may comprise any convenient shape without departing from the spirit of the present invention. In this embodiment, diameter 304 of inner surface 302 is generally constant throughout the length of wrap 300. Wrap 300 may be open at both ends, resembling a sleeve, and is adapted to securely encompass at least one electrical wire when unrolled. Accordingly, the wrap is capable of expanding greater than or shrinking smaller than the wrap's rolled diameter to securely encompass at least one wire. As shown in FIG. 3B, wrap 306 may also stretch in the midsection to allow for additional room to secure the twisted bare conductors of the wires to be spliced. Due to the highly elastic nature of wrap 306, bulge diameter 312 may be significantly greater than diameter 310 of inner surface 308 while still securely encompassing the wires to be spliced.

As shown in FIG. 3C, unrolled wrap 314 may also stretch at one or both ends, allowing for a tight fit about irregular splice geometries. Diameter 320 of inner surface 316 may be slightly smaller or larger than the diameter of the wires to be spliced. Tapered diameter 318 may approach or even be smaller than diameter 320 of inner surface 316. This arrangement may allow for a tighter, more secure fit as the wrap is unrolled over the splice area.

The entire unrolled wrap 300, 306, or 314 is highly elastic, creating a secure sleeve once unrolled. As shown in FIGS. 3A, 3B, and 3C, if wrap 300, 306, or 314 is not unrolled down at least one wire, the wrap lays almost flat because of its elastic properties. The total length, diameter, and circumference of unrolled wrap 10 may vary depending on the gauge of the wires to be spliced. In the preferred embodiment, the unrolled wrap is approximately 2.5 cm long, 7 mils thick, and is used to splice standard 14 AWG (American Wire Gauge) electrical wires (as found in many common household electrical devices). The wrap may, however, be any convenient size, length, or thicknesses depending on the properties of the wires to spliced, the current carried within the wires, environmental conditions, or other considerations.

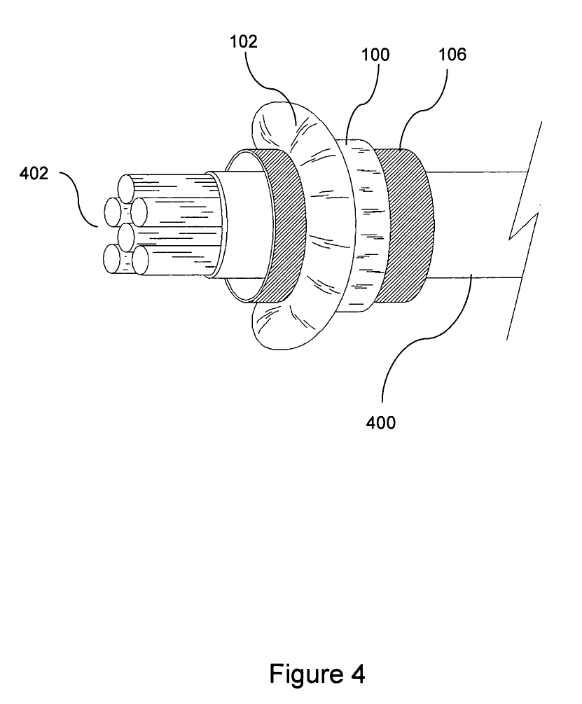

FIG. 4 shows the first step in preparing the present invention to splice electrical wires. Core 106 of the present invention is slid over the terminal end of wire 400. Core 106 of the present invention may be manufactured in various sizes in order to accommodate various gauge wires. For example, core 106 may be manufactured to have a diameter slightly larger than 11.684 mm to accommodate a single OOOO AWG wire or a diameter slightly larger than 0.07874 mm to accommodate a single 40 AWG wire (or core 106 may exhibit any diameter in between). In the preferred embodiment, core 106 is adapted to fit around a single electrical wire; however, core 106 may be adapted to fit around several wires simultaneously. While in the described embodiment wire 400 is a standard 12 AWG electrical wire, it should be clearly understood that wire 400 is not limited to a traditional electrical wire and may be of any gauge. Wire 400 can comprise any wire or cable capable of being spliced, including signal transmission wires and cables, electrical wires, coaxial cables, fiber cables, and cable bundles. Also in the preferred embodiment, wrap 100, core 106, or under surface 102 may be color-coded for ease of use. Different colored wraps and cores may be manufactured to correspond to various wire gauges. The terminal end of wire 400 is stripped of its insulation exposing the wire's bare conductors 402.

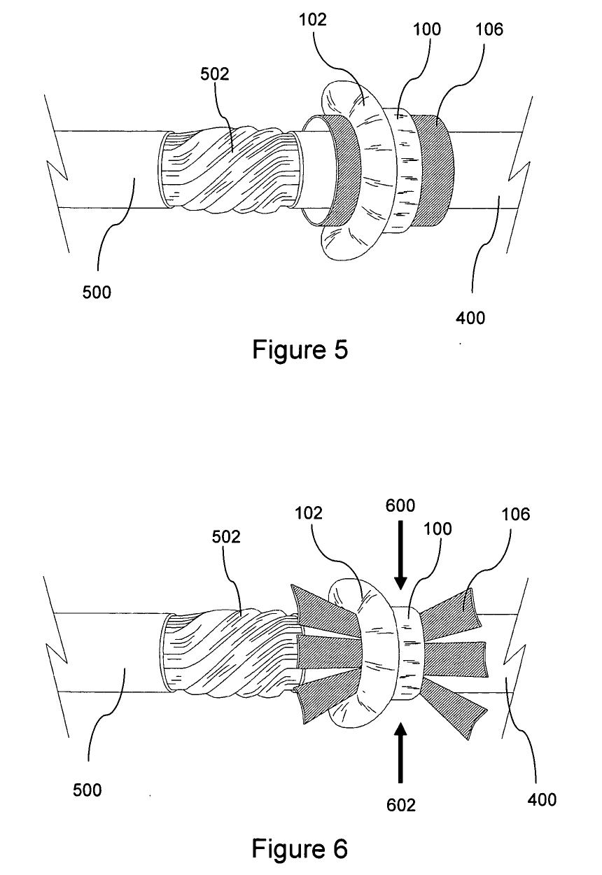

Now referring to FIG. 5, core 106 of the present invention is positioned over the start of the desired splice area of electrical wire 400. Wrap 100 in its rolled state is rolled about core 106 exposing under surface 102 of wrap 100. Bare conductors 502 of wire 400 and wire 500 may be twisted or otherwise joined together. Although the described embodiments and illustrations depict the splicing of two standard electrical wires, it should be clearly understood that the present invention is not limited to splicing only two wires; rather, it is contemplated that the present invention may be adapted to splice any number of wires.

Referring to FIG. 6, pressure may be applied to pressure points 600 and 602 causing a break or fracture of core 106 of the present invention. In the preferred embodiment, fracturing core 106 activates a rubber-based pressure-sensitive adhesive (PSA) positioned on under surface 102 of wrap 100. This adhesive may be activated upon pressure being applied to pressure points 600 and 602. This pressure-sensitive adhesive may lock one end of wrap 100 in place about the terminal end of wire 400. As the wrap is unrolled, fractured core 106 remains at the terminal end of wire 400, and shards of fractured core 106 are free to fall to either side of wire 400. Fractured core 106 may additionally comprise perforations and/or reinforced areas to control the direction and progress of the fractures.

In an alternative embodiment, a suitable gel sealing material or adhesive, such as silicone-based gel, a urea-based gel, or a urethane-based gel, is held within the core of the present invention. The core may be designed in a tapered manner to allow the lateral flow of the gel substance upon fracturing of the core. As the wrap is unrolled, the gel substance is spread laterally until the wrap is completely unrolled. This results in a generally even application of the gel substance over the entire area of the wire splice. Shards of core 106 may be discarded to either side of wire 400 before the gel forms a seal encompassing the splice. The gel substance may include a variety of additives, including stabilizers and antioxidants such as hindered phenols, phosphites, sulfides, light stabilizers, and flame retardants, such as halogenated paraffins and/or phosphorous containing organic compounds, as common in the art. Other suitable gel additives that may be used with the present invention include colorants, biocides, tackfiers, and the like.

In yet another embodiment, the core of the present invention dissolves while the wrap is unrolled. In this embodiment, there may be no resultant shards of core 106 of the present invention. The core may comprise a dissolvable film (such as the Velox® film manufactured by National Starch & Chemical or any other dissolvable or dissipated film or product). The properties of the film may allow it to dissolve at any desired dissolution rate and become an adhesive. As the wrap is unrolled, the core may dissolve at a constant rate until the wrap is fully unrolled, at which time the core is completely dissolved. The chemical reaction causing the dissolvable film to decompose is well known in the art. The dissolvable film core may additionally aid in the adhesion process.

In yet another embodiment of the present invention, the core does not fracture and remains intact around wire 400. In this embodiment, the wrap is simply unrolled off core 106 to encompass the splice area. Pressure may or may not be required at pressure points 600 and 602; rather, the core may be positioned over the terminal end of wire 400 and unrolled over the bare conductors of the wires to be spliced by holding core 106 in place.

Still referring to FIG. 6, once pressure is applied to pressure points 600 and 602, the present invention may be locked in place at the start of the splice area due to a pressure-sensitive adhesive applied to the backing of the wrap, the inner surface of core 106, or within core 106 itself. In other embodiments, adhesives are not used; rather, the elastic properties of the wrap flattening out against itself are sufficient to cause a secure lock around wire 400. A user of the present invention unrolls the wrap to cover bare conductors 502 of wire 400 and wire 500 until the wrap is exhausted and fully unrolled. Typically, the length of the wrap is directly proportional to the gauge of the wires to be spliced and is of sufficient length to completely encompass and to securely splice bare conductors 502.

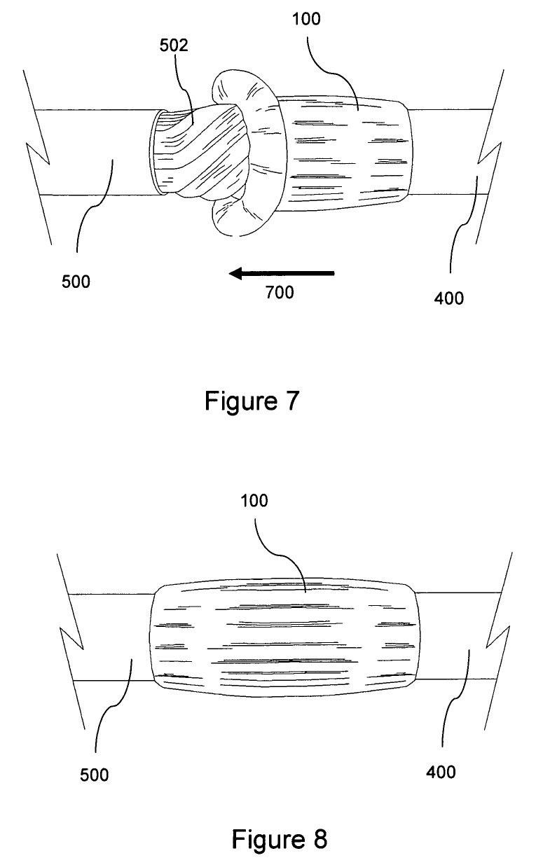

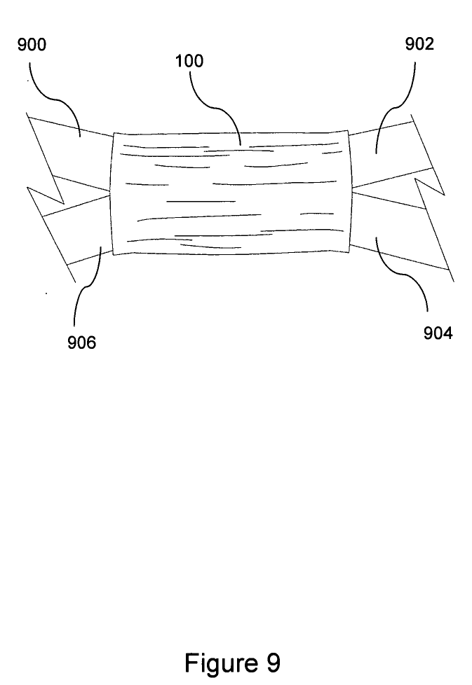

Now referring to FIG. 7, wrap 100 is unrolled in direction 700 to encompass the entire splice area and bare conductors 502. This process forms a secure cover over bare conductors 502 of wire 400 and wire 500. As shown in FIG. 8, wrap 100 completely covers and protects the bare conductors of the spliced wires 400 and 500 to reduce the risk of unwanted short circuits and degradation of signal quality. Due to the highly elastic nature of wrap 100, wrap 100 resists sliding and unrolling from the splice area. In addition, as common in the art, wrap 100 may be designed to resist tearing, corrosion, puncturing, and abrasion and exhibit other properties commonly found in electrical insulating tape. In the preferred embodiment, wrap 100 is also UL 510 flame retardant. Thus, a secure splice is formed between electrical wires 400 and 500.

The present invention is not limited to splicing two wires. More than two wires may also be securely spliced using the present invention. As shown in FIG. 9, wires 900, 902, 904, and 906 may be spliced using the present invention. Wrap 100 is unrolled to fully encompass the bare conductors of multiple wires.

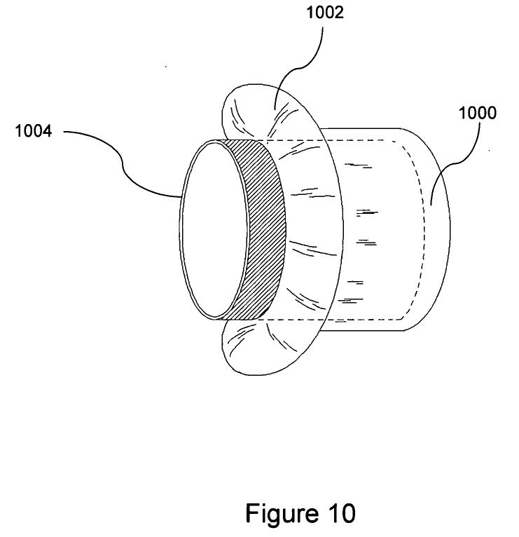

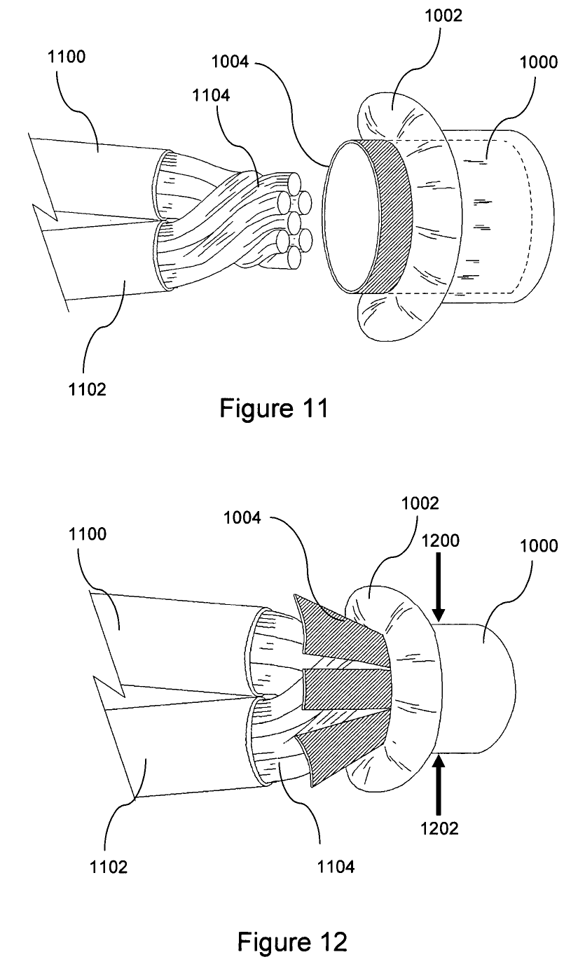

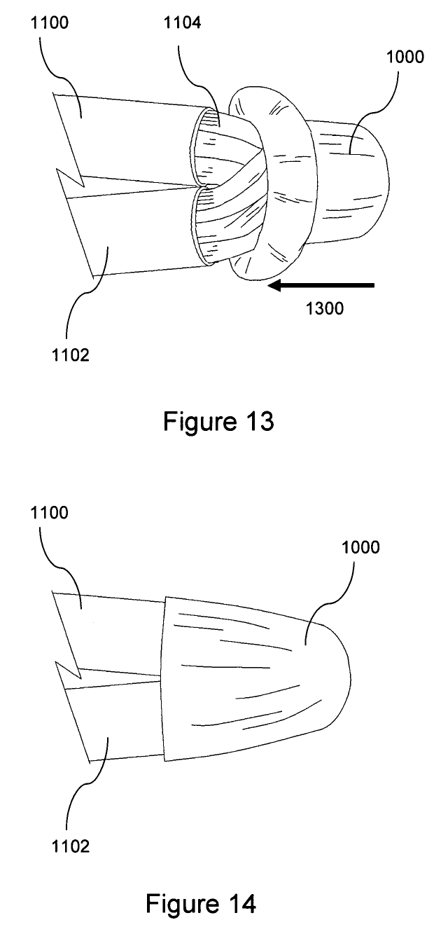

As shown in FIG. 10, in an alternative embodiment of the present invention wrap 1000 exhibits only one opening disposed at one end. This embodiment serves the purpose of typical splice caps and twist-on wire nuts commonly found in the art. Wrap 1000 is similarly rolled back upon itself about core 1004. As shown in FIGS. 11 and 12, core 1004 is positioned over the terminal end of wires 1100 and 1102, whose bare conductors 1104 are twisted together. As shown in FIG. 12, pressure is applied to pressure points 1200 and 1202, causing core 1004 to fracture. Wrap 1000 is unrolled in direction 1300, as depicted in FIG. 13, until wrap 1000 fully encompasses bare conductors 1104 of wires 1100 and 1102. The core may fall to either side of the present invention as wrap 1000 is unrolled, or the core may be dissolvable. FIG. 14 depicts fully unrolled wrap 1000 covering the entire splice area. Because of the highly elastic nature of wrap 1000, wires 1100 and 1102 are securely spliced and not easily prone to separation, even when pulled.

From the foregoing description of the preferred embodiments, which embodiments have been set forth in considerable detail for the purpose of making a complete disclosure of the present invention, it can be seen that the present invention comprises a simple, economical, and effective instant splice device. It will be appreciated by those skilled in the art that changes could be made to the embodiment described above without departing from the broad inventive concept thereof. It is understood, therefore, that this invention is not limited to the particular embodiment disclosed, but it is intended to cover all modifications that are within the scope and spirit of the invention as defined by the appended claims.

What is claimed is:

1. A device for splicing a plurality of wires comprising:
an elastic insulating wrap;
a fracturable core adapted to slide over the terminal end of at least one wire;
wherein said insulating wrap is rolled back upon itself about said core.

2. A device as described in claim 1 wherein said insulating wrap is plastic.

3. A device as described in claim 1 wherein said insulating wrap exhibits an insulation resistance of approximately 1×10⁶ megaohms.

4. A device as described in claim 1 wherein said insulating wrap contains an adhesive backing.

5. A device as described in claim 4 wherein said adhesive backing is selected from the group consisting of thermosetting rubber adhesive, acrylic adhesive, thermosetting silicon adhesive, non-thermosetting rubber adhesive, and pressure-sensitive adhesive.

6. A device as described in claim 1 wherein said fracturable core is generally cylindrical or tubular.

7. A device as described in claim 1 wherein said fracturable core is tapered at both ends.

8. A device as described in claim 1 wherein said fracturable core contains a gel-filled layer.

9. A device as described in claim 1 wherein said fracturable core is removed upon installation.

10. A device as described in claim 1 wherein said fracturable core is dissolvable.

11. A device for splicing a plurality of wires comprising:
an elastic insulating wrap;
a core adapted to slide over the terminal end of at least one wire;
wherein said insulating wrap is rolled back upon itself about said core.

12. A device as described in claim 11 wherein said insulating wrap is plastic.

13. A device as described in claim 11 wherein said insulating wrap exhibits an insulation resistance of approximately 1×10⁶ megaohms

14. A device as described in claim 11 wherein said core contains a gel-filled layer.

15. A device as described in claim 11 wherein said core is removed upon installation.

16. A device as described in claim 11 wherein said core is dissolvable.

17. A device as described in claim 11 wherein said insulating wrap contains an adhesive backing.

18. A method for splicing a plurality of wires, said method comprising the steps of:
(a) providing an elastic insulating wrap rolled back upon itself about a core;
(b) positioning said core over a terminal end of a wire to be spliced;
(c) unrolling said wrap to cover at least a portion of said first wire and a second wire.

19. A method as described in claim 18 comprising the additional step of applying pressure to said core causing said core to fracture before said unrolling step.

20. A device for splicing a plurality of wires comprising:
an elastic insulating sleeve closed at one end;
a core adapted to slide over the terminal end of at least one wire;
wherein said insulating wrap is rolled back upon itself about said core and comprises an adhesive on the under surface of said insulating wrap.
